(19) United States
(12) Patent Application Publication
(10) Pub. No.: US 2005/0185082 A1
(43) Pub. Date: Aug. 25, 2005

(54) Focusing method for digital photographing apparatus

(75) Inventors: Byoung-kwon Lee, Seongnam-si (KR); Hyon-soo Kim, Seoul (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/029,596

(22) Filed: Jan. 5, 2005

(30) Foreign Application Priority Data
Feb. 19, 2004 (KR) 10-2004-0011015

(51) Int. Cl. H04N 5/232

(52) U.S. Cl. 348/345

(57) ABSTRACT

Provided is a focusing method for a digital photographing apparatus by which an image is displayed while a focal lens is moved in response to a manual operation signal generated by a user. The method includes: obtaining a focus value at a current position of the focal lens, wherein the focus value is proportionate to an amount of high-frequency components contained in an image displayed currently; determining a focusing state at the current position of the focal lens based on the focus value of the current position; and changing a sharpness of the currently displayed image such that the result of the determination of the focusing state can be expressed in the currently displayed image. A digital photographing apparatus using the method is also provided.

### BACKGROUND OF THE INVENTION

This application claims the priority of Korean Patent Application No. 10-2004-0011015, filed on Feb. 19, 2004, in the Korean Intellectual Property Office, the disclosure of which is incorporated herein in its entirety by reference.

1. Field of the Invention

The present invention relates to a method of controlling a digital photographing apparatus, and more particularly, to a focusing method for a digital photographing apparatus, in which an image is displayed while a focal lens is moved in response to a manual operation signal generated by a user.

2. Description of the Related Art

FIG. 1 illustrates focus values of a digital photographing apparatus with respect to positions of a focal lens according to a conventional focusing method for a digital photographing apparatus. Here, reference numeral DS indicates the number of position steps of the focus motor M_{F}, and reference numeral FV indicates a focus value, that is, the amount of high-frequency components contained in an image signal. As shown in FIG. 1, the focus value linearly increases or decreases based on the focal position m. When the focal lens is at a focal position m, the outline of the image of the subject is the clearest. In other words, as illustrated in FIG. 1, the focus value of the image of the subject is the largest at the focal position m of the focal lens. As the focal lens approaches the focal position m, the focus value becomes larger. After the focal lens passes the focal position m, as the focal lens gets farther from the focal position m, the focus value becomes lower.

An exemplary conventional focusing method is the through-the-lens (TTL) method, i.e., the so-called high-frequency climbing method. In the TTL method, high frequency components, such as a focus value, of an image of a subject are analyzed while the focal lens is moved and, based on the result of the analysis, focusing is performed. In the TTL method, a maximum focus value (a position at which the focal value that has been increasing starts to decrease) is detected and focusing is performed based on the detected position.

Another conventional focusing method is the automatic focusing method in which a camera automatically determines an in-focus position and moves a focal lens to the in-focus position. Also, a manual focusing method in which a user determines an in-focus position while viewing a display device such as an LCD and moves the focal lens to the in-focus position may be used as the focusing method. However, in the manual focusing method, the user may have difficulties in accurately determining an in-focus position while viewing the image on a small display device of the conventional digital photographing apparatus.

To solve this problem, a conventional manual focusing method disclosed in Japanese Patent Laid-open No. 2002-72332 may be used. This method requires a separate focusing information display unit such that a user can view focusing information displayed on the focusing information display unit and easily adjust the focus while checking a focusing state.

Alternatively, in another conventional manual focusing method for a digital photographing apparatus, distance data of a subject may be presented in a bar-shaped on-screen display (OSD) such that a user can easily determine an in-focus position. However, when focusing information is displayed on a small screen of a display device in the OSD, the OSD covers the screen, thereby making the user unable to properly check the screen.

### SUMMARY OF THE INVENTION

The present invention provides a focusing method for a digital photographing apparatus wherein a user is able to easily determine a current focusing state even if additional focusing information is not displayed in an image displayed on a display device of the digital photographing apparatus.

According to an embodiment of the present invention, there is provided a focusing method for a digital photographing apparatus by which an image is displayed while a focal lens is moved in response to a manual operation signal generated by a user. The method includes obtaining a focus value at a current position of the focal lens, wherein the focus value is proportionate to an amount of high-frequency components contained in an image displayed currently; determining a focusing state at the current position of the focal lens based on the focus value of the current position; and changing a sharpness of the currently displayed image such that the result of the determination of the focusing state can be expressed in the currently displayed image.

In the method, the result of the determination of a focusing state is expressed in a currently displayed image in response to a manual operation signal generated by a user. Accordingly, the user can easily determine a current focusing state even if additional focusing information is not displayed on a display device of the digital photographing apparatus.

### BRIEF DESCRIPTION OF THE DRAWINGS

The above and other features and advantages of the present invention will become more apparent by describing in detail exemplary embodiments thereof with reference to the attached drawings in which:

FIG. 1 is a graph illustrating focus values with respect to positions of a focal lens according to a conventional focusing method of a digital photographing apparatus;

FIG. 2 is a perspective view illustrating the front and the top of a digital camera according to an embodiment of the present invention;

FIG. 3 is a perspective view illustrating the back of the digital camera of FIG. 2;

FIG. 4 illustrates the structure of a portion of the digital camera of FIG. 2 on which light is incident;

FIG. 5 is a schematic diagram of the configuration of the digital camera of FIG. 2;

FIG. 6 is a flowchart illustrating a photographing control program of a digital signal processor (DSP) illustrated in FIG. 5;

FIG. 7 is a flowchart illustrating an operation program of the DSP of FIG. 5 in a manual focusing mode;

FIGS. 8A and 8B are graphs illustrating focus values with respect to positions of a focal lens and a first-order differential value between the focus values; and

FIG. 9 is a flowchart illustrating an operation program of the DSP of FIG. 5 in an automatic focusing mode.

### DETAILED DESCRIPTION OF THE INVENTION

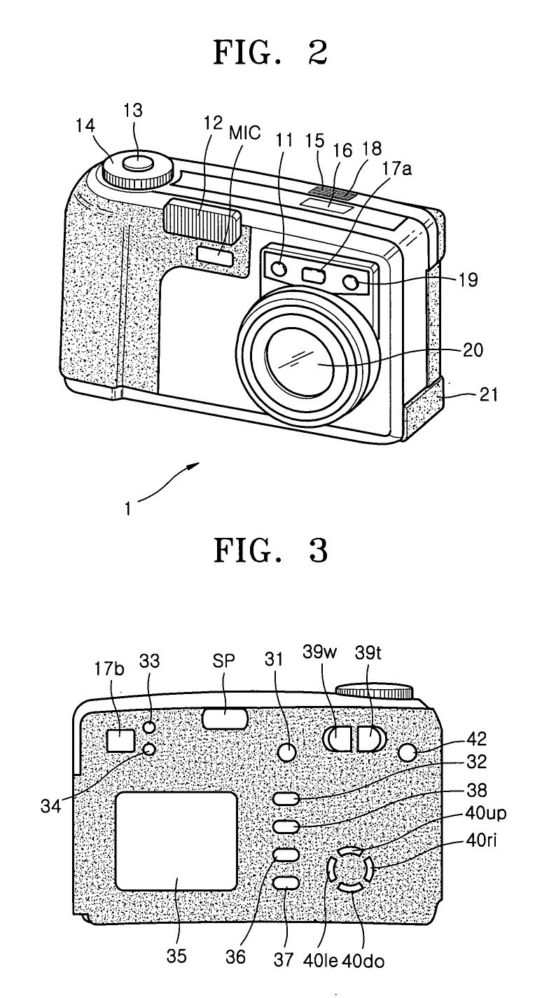

FIG. 2 is a perspective view illustrating the front and the top of a digital camera 1 according to an embodiment of the present invention. Referring to FIG. 2, a digital camera 1 includes a microphone MIC, a self-timer lamp 11, a flash 12, a shutter button 13, a mode dial 14, a function-selection button 15, a photographing information-display unit 16, a viewfinder 17a, a function-block button 18, a flash light intensity sensor 19, a lens unit 20, and an external interface 21.

In a self-timer mode, the self-timer lamp 11 operates for a set period of time from the time when the shutter button 13 is pressed to the time when a shutter operates. The mode dial 14 is used for selecting and setting any one of a plurality of operating modes of the digital camera 1. Exemplary operating modes of the digital camera 1 include a still-image photographing mode, a night view photographing mode, a moving-image photographing mode, a reproducing mode, a computer connection mode, and a system setting mode.

The function-selection button 15 is used for selecting any one of the operating modes of the digital camera 1 such as the still-image photographing mode, the night view photographing mode, the moving-image photographing mode, and the reproducing mode. The photographing information-display unit 16 displays information regarding each photographing related function. The function-block button 18 is used when a user selects a function displayed on the photographing information-display unit 16.

FIG. 3 is a perspective view illustrating the back of the digital camera 1 of FIG. 2. Referring to FIG. 3, the back of the digital camera 1 includes a speaker SP, a power button 31, a monitor button 32, an automatic focusing lamp 33, a viewfinder 17b, a flash standby lamp 34, a color LCD panel 35, a confirm/delete button 36, an enter/reproduce button 37, a menu button 38, a wide angle-zoom button 39_{W}, a telephoto-zoom button 39_{T}, an up button 40up, a right button 40ri, a down button 40do, and a left button 40le.

The monitor button 32 is used for controlling the operation of the color LCD panel 35. For example, when the user presses the monitor button 32, an image and photographing information are displayed on the color LCD panel 35. When the user presses the monitor button 32 again, only the image is displayed on the color LCD panel 35. When the user presses the monitor button 32 three times, the color LCD panel 35 is turned off.

The automatic focusing lamp 33 operates when automatic focusing is completed. The flash standby lamp 34 operates when the flash 12 of FIG. 2 is in a standby mode. The confirm/delete button 36 is used for confirmation or deletion in the process of setting a mode. The enter/reproduce button 37 is for inputting data, or for stopping or reproduction in a reproducing mode. The menu button 38 is used to display menus for a mode selected from the mode dial 14. The up button 40up, right button 40ri, the down button 40do, and the left button 40le are used in the process of setting a mode.

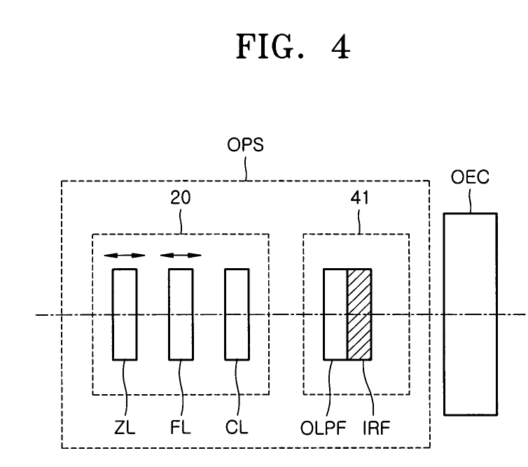

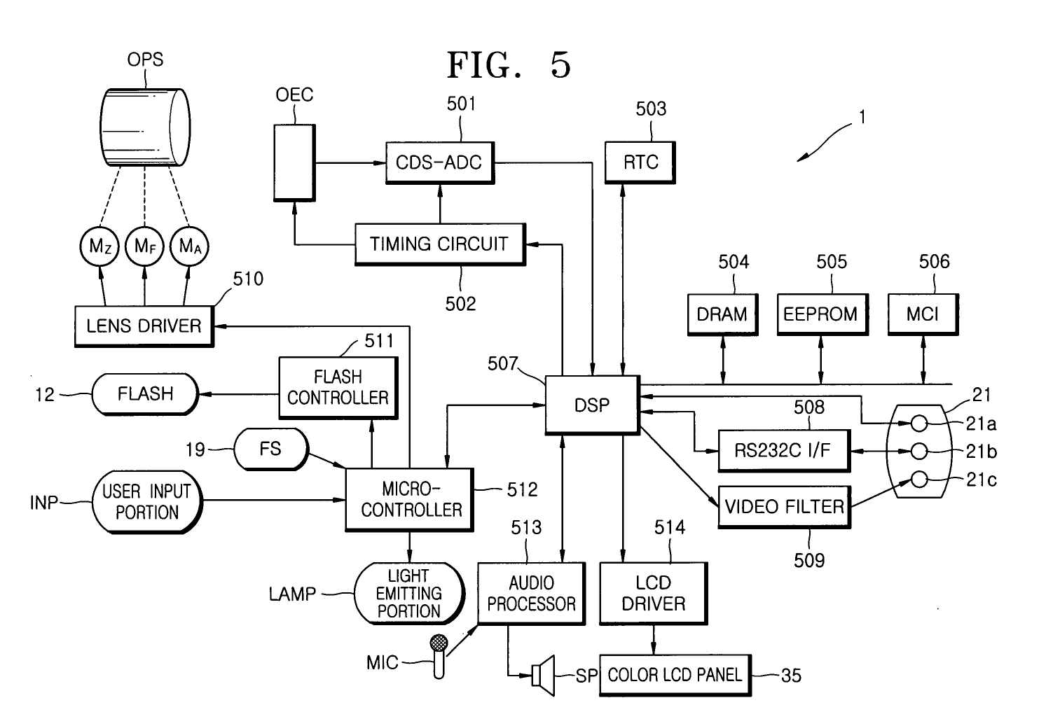

FIG. 4 illustrates the structure of a portion of the digital camera 1 of FIG. 2 on which light is incident. FIG. 5 is a schematic diagram of the configuration of the digital camera 1 of FIG. 2.

Referring to FIGS. 4 and 5, an optical system (OPS) including the lens unit 20 and a filter unit 41 optically processes light. The lens unit 20 includes a zoom lens ZL, a focal lens FL, and a compensation lens CL.

When the user presses the wide angle-zoom button 39_{W} (see FIG. 3) or the telephoto-zoom button 39_{T} (see FIG. 3) included in a user input unit (INP), a signal corresponding to the wide angle-zoom button 39_{W} or the telephoto-zoom button 39_{T} is relayed to a micro-controller 512. Accordingly, the micro-controller 512 controls a lens driver 510, thereby running a zoom motor M_{Z}, which, in turn, moves the zoom lens ZL. In other words, when the user presses the wide angle-zoom button 39_{W}, the focal length of the zoom lens ZL becomes short, thereby widening the angle of view. When the user presses the telephoto-zoom button 39_{T}, the focal length of the zoom lens ZL becomes long, thereby narrowing the angle of view. Thus, the micro-controller 512 can calculate the angle of view with respect to the position of the zoom lens ZL based on design data of the OPS. Since the position of the focal lens FL is adjusted in a state where the position of the zoom lens ZL is set, the angle of view is hardly affected by the position of the focal lens FL.

If a subject is automatically or manually focused on, the position of the focal lens FL changes with respect to a subject distance Dc. Since the position of the focal lens FL is adjusted when the position of the zoom lens ZL is set, the subject distance Dc is affected by the position of the zoom lens ZL.

In an automatic focusing mode, a main controller controls the lens driver 510 through the micro-controller 512, thereby driving a focus motor M_{F}. Accordingly, the focal lens FL can be moved by steps, each step being of a predetermined distance, and the focus value is calculated at each step. In this process, the position of the focal lens FL, at which a focus value proportionate to the amount of high frequency components contained in an image signal is largest can be determined and the number of steps required by the focus motor M_{F} to reach the position can be set.

The compensation lens CL is not separately operated because the compensation lens CL compensates for the entire refractive index. Reference numeral M_{A} indicates a motor driving an aperture (not shown). The aperture-driving motor M_{A} has a different rotation angle when in a designated exposure mode than it does when it is not in the designated exposure mode. In the designated exposure mode, a designated detection region may be set. When a designated detection region is set, the exposure of the digital camera 1 is set according to an average luminance of the designated detection region. Thus, the designated exposure mode can be used to force the digital camera 1 to set the exposure based on the average luminance of only a portion of a subject by matching a designated detection region displayed on the color LCD panel 35 of the digital camera 1 with a selected portion of the subject.

An optical low pass filter (OLPF) included in the filter unit 41 of the OPS eliminates high frequency optical noise. An infrared cut filter (IRF) included in the filter unit 41 of the OPS blocks the infrared component of incident light.

A photoelectric conversion unit (OEC) of a charge coupled device or a complementary metal oxide (CMOS) semiconductor converts light from the OPS into an analog electrical signal. Here, the DSP 507 controls a timing circuit 502 to control the operations of the OEC and a correlation-double-sampler-and-analog-to-digital converter (CDS-ADC) 501. The CDS-ADC 501 processes an analog signal from the OEC, eliminates the high frequency noise, adjusts an amplitude of the analog signal, and then converts the analog signal into a digital signal.

The DSP 507, which controls the entire operation of the digital camera 1 according to programs stored in an electrically erasable and programmable read only memory (EEPROM) 505, processes the digital signal from the CDS-ADC 501 and generates a digital image composed of luminance and chromaticity values. The digital image signal from the DSP 507 is input to an LCD driver 514, thereby displaying an image on the color LCD panel 35.

The digital image signal from the DSP 507 can be transmitted via a universal serial bus (USB) connector 21 a or via an RS232C interface 508 and an RS232C connector 21b for serial communications. The digital image signal from the DSP 507 can also be transmitted via a video filter 509 and a video output unit 21c as a video signal.

Referring to FIGS. 2, 3, and 5, a light emitting portion (LAMP) operated by the micro-controller 512 includes the self-timer lamp 11, the automatic focusing lamp 33, and the flash standby lamp 34. The user input portion (INP) includes the shutter button 13, the mode dial 14, the function-selection button 15, the function-block button 18, the monitor button 32, the confirm/delete button 36, the enter/reproduce button 37, the menu button 38, the wide angle-zoom button 39_{W}, the telephoto-zoom button 39_{T}, the up button 40up, the right button 40ri, the down button 40do, and the left button 40le.

A dynamic random access memory (DRAM) 504 temporarily stores a digital image signal from the DSP 507. The EEPROM 505 stores programs and setting data needed for the operation of the DSP 507. Thus, the EEPROM 505 is an example of a recording medium on which a program for implementing the focusing method according to the present invention is recorded. A user's memory card is inserted or removed in a memory card interface 506.

An audio processor 513 can relay sound from the microphone MIC to the DSP 507 or to a speaker SP. In addition, the audio processor 513 can output an audio signal from the DSP 507 to the speaker SP. The micro-controller 512 controls the operation of a flash controller 511 in response to a signal from the flash light intensity sensor 19, thereby driving the flash 12.

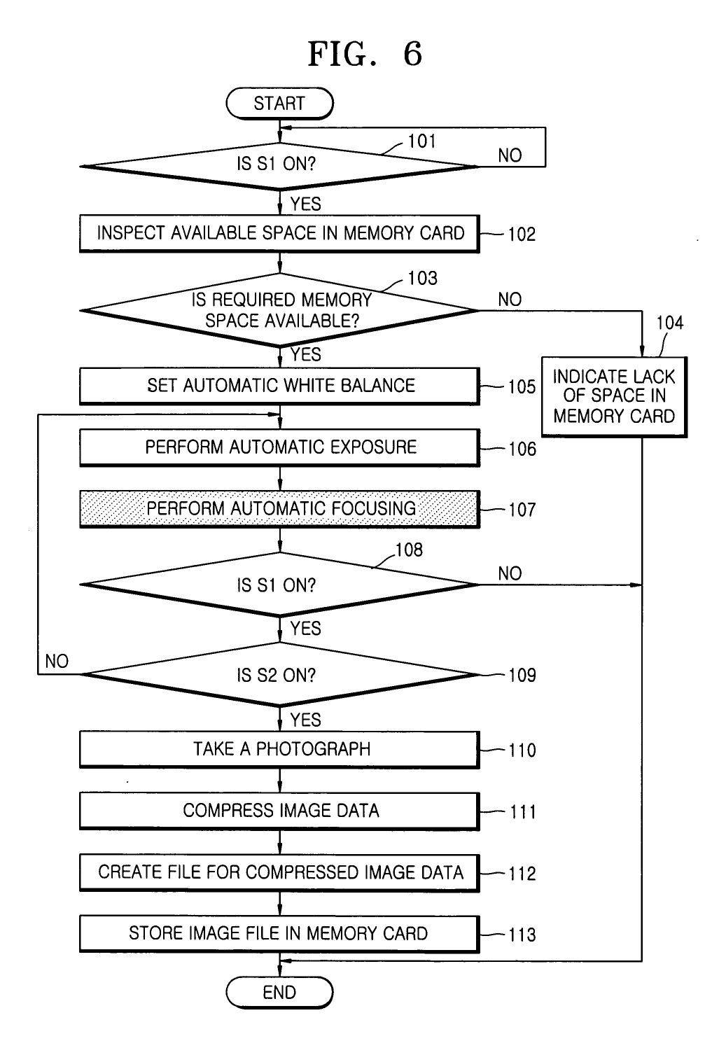

FIG. 6 is a flowchart illustrating a photographing control program of the DSP 507 illustrated in FIG. 5. The photographing control program of the DSP 507 will now be described with reference to FIGS. 2 through 6. The shutter button 13 included in the INP has two levels. In other words, when a user lightly depresses the shutter button 13 to a first level, a first level signal S1 from the shutter button 13 is turned on. Thus, the photographing control program of the DSP 507 of FIG. 5 starts when the user depresses the shutter button 13 to the first level (operation 101). Here, a current position of the zoom lens ZL is already set.

The DSP 507 inspects the remaining capacity of the memory card (operation 102) and determines whether the memory card has enough capacity for recording a digital image signal (operation 103). When the memory card does not have enough recordable capacity, the DSP 507 indicates the lack of capacity of the memory card (operation 104). When the memory card has enough recordable capacity, the following steps are performed.

In an automatic white balance (AWB) mode, parameters related to the AWB are set (operation 105). In an automatic exposure (AE) mode, the DSP 507 calculates the exposure by measuring incident luminance and drives the aperture driving motor M_{A} according to the calculated exposure (operation 106). In the automatic focusing (AF) mode, a current position of the focal lens FL is set (operation 107).

It is next determined whether the first level signal S1 from the shutter button 13 is on (operation 108). When the first level signal S1 is not on, it means that the shutter button 13 has not been depressed to initiate photographing. Therefore, an execution program is terminated. When the first level signal S1 is on, the following operations are performed.

After determining that S1 is on, the DSP 507 determines whether the second level signal S2 is activated (operation 109). When the second level signal S2 is not on, it means that the user did not fully depress the shutter button 13 to the second level in order to take a photograph. Therefore, the execution program returns to operation 106 and performs operations 106-109 again.

When the second level signal S2 is on, it means that the user fully depressed the shutter button 13 to the second level. Therefore, a photographing operation is performed (operation 110). In other words, the DSP 507 is operated by the micro-controller 512, and the OEC and the CDS-ADC 501 are operated by the timing circuit 502 in order to capture an image of an object.

Next, image data is compressed (operation 111), and an image file for the compressed image data is created (operation 112). The image file created by the DSP 507 is stored in a storage medium. In an embodiment the image file created by the DSP 507 is stored in a memory card via the memory card interface 506 (operation 113). After the image file is stored, the photographing control algorithm is terminated.

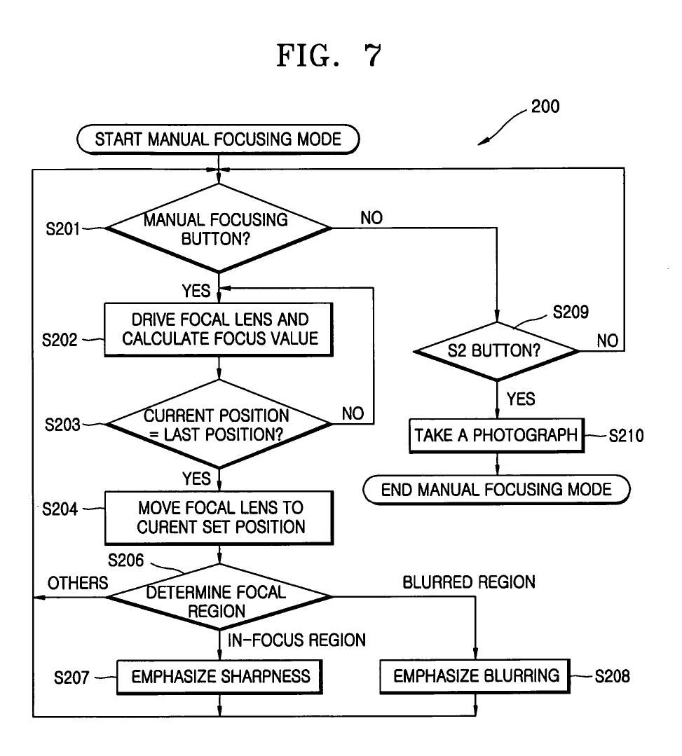

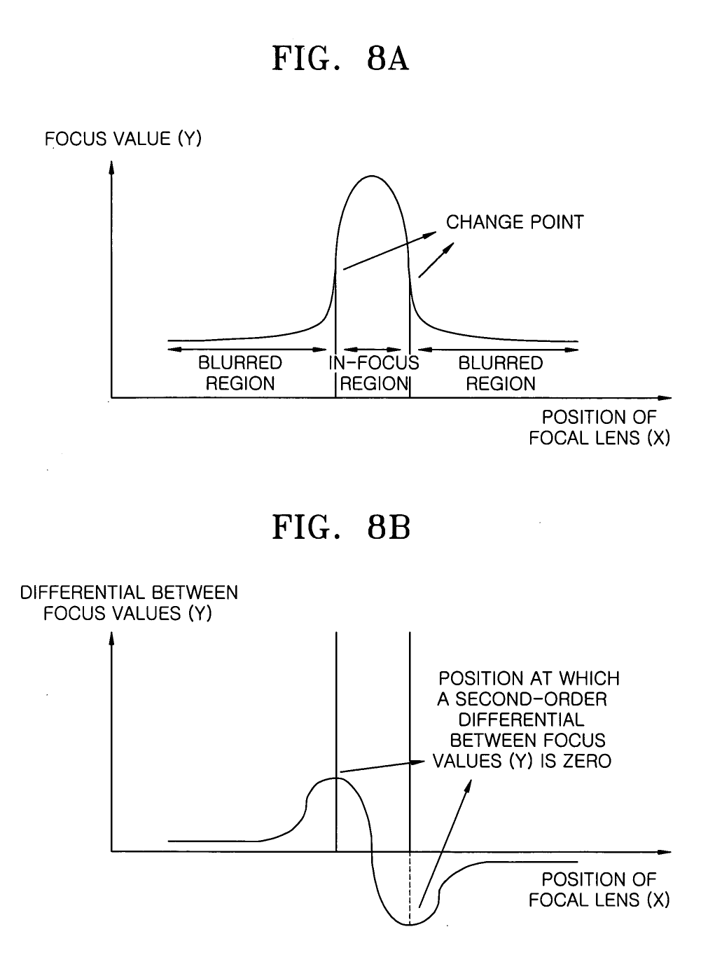

FIG. 7 is a flowchart illustrating an operation program of the DSP 507 of FIG. 5 in a manual focusing mode. FIGS. 8A and 8B are graphs illustrating focus values with respect to positions of a focal lens and a first-order differential value between the focus values.

Referring to FIGS. 7 through 8B, a manual focusing program 200 of the digital camera 1 relates to displaying an image while moving the focal lens FL of FIG. 4 in response to manual operation signals generated by the user. The manual focusing program 200 includes detecting focus values (operations S202 and S203), moving the focal lens FL (operation S204), determining a focusing state (operation S206), and emphasizing the focusing state (operations S207 and S208).

The manual focusing program 200 is performed according to whether a manual focusing button is pressed (operation S201). Thus, the manual focusing button may be included in the digital camera 1. The manual focusing button may include a far button for focusing on an object which is a distance far from the digital camera 1 and a near button for focusing on an object which is a distance near to the digital camera 1.

In general, the manual focusing program 200 is used when a subject is at a fixed distance, such as infinity, 2.5 meters, or 1 meter, away from the digital camera 1. It is recommended that the manual focusing program 200 be used especially when automatic focusing is impossible due to, for example, a dark subject or a monochromatic subject.

The focus motor M_{F} is driven in units of steps by operating the far button or the near button to find a position of the focal lens FL at which a focus value proportionate to the amount of high frequency components contained in the image signal is the largest. A focus value may be obtained by integrating over an entire focal region values which are obtained by high-frequency-filtering an image signal based on a cutoff frequency.

The focal region is where a focus value is obtained in the entire image region. The entire image region may be the focal region, but it may be more efficient to define a region displayed on a portion of the display device as the focal region. In particular, the focal region may be a quarter and half of the screen of the display device horizontally and vertically, respectively, and may be located at a center of the screen.

When the manual focusing button has been pressed (operation S201), focus values are detected while moving the focal lens FL of FIG. 4 in one direction from a reference position by a predetermined number of steps (operations S202 and S203). To this end, the focus motor M_{F} is driven to move the focal lens FL from the reference position, i.e., a current position, to a set ending position. In this process, focus values are calculated. Here, the focus values proportionate to the amount of high-frequency components contained in an image signal are calculated while driving the focus motor M_{F} in units of a first number of steps, for example, 8 steps, during which the focal lens FL is moved from the current position to the ending position.

A focus value may be obtained by high-frequency-filtering the image signal based on a cutoff frequency higher than the conventional cutoff frequency. To this end, in the present embodiment, any one of a frequency larger than a hundredth of a sampling frequency for processing the image signal and a frequency smaller than a tenth of the sampling frequency may be set as the cutoff frequency. Then, the focus value is obtained by integrating values obtained by high-frequency-filtering the image signal based on the cutoff frequency.

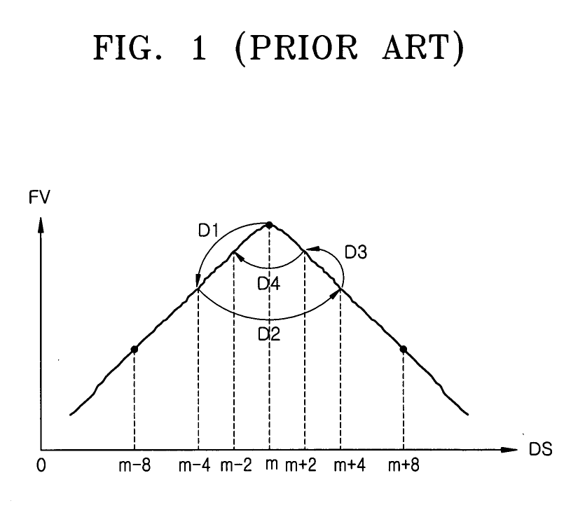

FIG. 8A is a graph illustrating focus values with respect to the position of the focal lens FL of FIG. 4. FIG. 8B is a graph illustrating a first-order differential of focus values. An in-focus region in the graph of FIG. 8A has larger inclination and is clearer than the in-focus region in the graph of FIG. 1. The graph of FIG. 8A has change points, i.e. inflection points, where a second-order differential value between the focus values is zero at a position of the focal lens FL having maximum and minimum differential values between the focus values. The region between the change points may be the in-focus region, and a region outside the in-focus region may be a blurred region.

In operation S204, the focal lens FL is moved to the current position by manually operating the manual focusing button. In operation S206, the focusing state at the current position is determined. The focusing state includes an in-focus state in which it is determined that the digital camera 1 is focused and a blurred state in which it is determined that the digital camera 1 is not focused. In the graphs illustrating focus values with respect to the position of the focal lens FL of FIGS. 8A and 8B, it is determined that the in-focus region between the change points is in the in-focus state, and a region outside the region between the change points is in the blurred state.

Alternatively, the focusing state at the current position of the focal lens FL may be determined by an inclination or slope between the focus values in the graphs of FIG. 8A and 8B. The inclination between the focus values is the difference between the focus value at the current position and the focus value at a previous step position. If the inclination is smaller than a first reference value, the focusing state may be the blurred state. If the inclination is larger than a second reference value which is bigger than the first reference value, the focusing state may be the in-focus state.

This method uses the fact that an inclination value in the in-focus region is larger than that in the blurred region. For example, the first reference value, which is the upper limit of small inclination in the blurred region, is set to 0.3 per step, and the second reference value, which is the lower limit of large inclination in the in-focus region, is set to 5.0 per step.

In operations S207 and S208, the sharpness of an image currently displayed is changed such that the result of determination of the focusing state can be expressed in the currently displayed image. Specifically, in operation 207, since the focal lens FL is in the in-focus region, the sharpness of the currently displayed image is enhanced, thereby emphasizing sharpness. In operation S208, since the focal lens FL is in the blurred region, the sharpness of the image is undermined, thereby emphasizing blurring.

The altered images displayed in operation 207 are obtained by high-frequency filtering current image signals. In contrast, in operation S208, the current image signals are low-frequency-filtered. A low-frequency filter or a high-frequency filter used to embody the present invention may be implemented, for example, as a filter included in an LCD driver 514 of FIG. 5 driving an LCD display device 35 of FIG. 5 or as an image processing block included in the DSP 507 of FIG. 5. After an altered image is displayed in operations S207 or operation S208, the program returns to operation S201.

If the manual focusing button has not been pressed (operation S201), it is determined whether a S2 signal from the shutter button 13 of FIG. 2 has been activated (operation S209). If the shutter button has been pressed to the second level, the photographing operation is performed (operation S210) and the manual focusing mode is terminated.

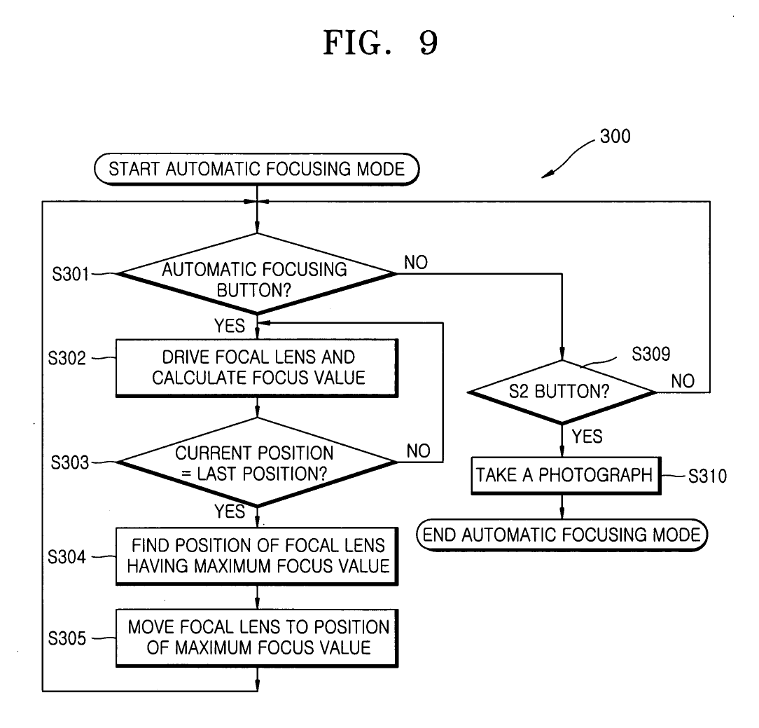

FIG. 9 is a flowchart illustrating an operation program 300 of the DSP 507 of FIG. 5 in an automatic focusing mode. The operation program 300 relates to finding a position of the focal lens FL at which a focus value proportionate to the amount of high-frequency components contained in an image signal is largest while driving the focus motor M_{F} in units of steps. The operation program 300 includes detecting focus values (operations S302 and S303), finding a position of the focal lens FL having a maximum focus value (operation S304), and moving the focal lens FL of FIG. 4 to the position of the maximum focus value (operation S305).

In operation S301, it is determined whether a signal has been generated by an automatic focusing button. Operation S301 can be replaced by operation 101 of FIG. 6 depending on the focusing mode set by the user.

In operations S302 and S303, focus values are detected while moving the focal lens FL in one direction from a reference position by a predetermined number of steps. To this end, any one of a frequency larger than a hundredth of a sampling frequency for processing the image signal and a frequency smaller than a tenth of the sampling frequency is set as the cutoff frequency. Then, the focus values proportionate to the amount of high-frequency components contained in the image signal are detected.

To this end, the focus motor M_{F} is driven to move the focal lens FL from the reference position, i.e., a current position, to a set ending position. In this process, focus values are calculated. Here, the focus values proportionate to the amount of high frequency components contained in the image signal are detected while moving the focus motor M_{F} in units of the first number of steps, for example, 8 steps, during which the focal lens FL is moved from the current position to the ending position. In this case, as in the embodiment of FIG. 7, focus values may be obtained from the graphs of FIGS. 8A and 8B.

In operation S304, the position of the focal lens FL having the maximum focus value is found. To this end, various methods of finding the position of the maximum focus value used in the conventional automatic focusing method may be used. One of the methods that can be used in the present embodiment will now be described.

After the focal lens FL is moved to a position of the maximum focus value out of the focus values calculated in units of the first number of steps, focus values at positions before and after a second number of steps, which is smaller than the first number of steps, for example, four steps, based on the position of the maximum focus value are measured and compared. In other words, the largest value out of the maximum focus value and the measured two values becomes a new maximum focus value.

Based on the position of the new maximum focus value, focus values at positions before and after a third number of steps, which is smaller than the second number of steps, for example, two steps, are measured and compared. In other words, the largest value of the maximum focus value and the current measured two values becomes the position of the focal lens FL having the final maximum focus value.

In operation S305, the focal lens FL is moved to the position of the final maximum focus value obtained in operation S304. When the focal lens FL is at the position of the final maximum focus value, if the shutter button is pressed to the second level and S2 is generated, an image is photographed (operation S310) and the automatic focusing mode is terminated.

The focusing method of the digital camera 1 according to the present invention may be applied to various image acquisition apparatuses such as digital still cameras that require automatic or manual focusing, digital video cameras, and portable phone cameras.

As described above, in a focusing method for a digital photographing apparatus according to the present invention, the result of the determination of a focusing state is expressed in a currently displayed image in response to a manual operation signal generated by a user. Accordingly, the user can easily determine a current focusing state even if additional focusing information is not displayed on a display device of the digital photographing apparatus.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method for focusing a digital photographing apparatus, the method comprising:
receiving light through a focal lens;
generating an image signal based on the received light;
calculating a focus value based on the high frequency component of the image signal;
displaying, based on the image signal, an image on a display screen; and
changing a sharpness of the displayed image based on the focus value.

2. The method of claim 1, further comprising
determining a focusing state based upon the focus value, wherein an in-focus state exists if it is determined that the digital photographing apparatus is focused and a blurred state exists if it is determined that the digital photographing apparatus is not focused.

3. The method of claim 1, further comprising:
moving the focal lens to a position in response to user input.

4. The method of claim 2, wherein
the in-focus state is indicated on the display by emphasizing a sharpness of the displayed image; and
the blurred state is indicated on the display by emphasizing a blurring of the displayed image.

5. The method of claim 4, wherein the sharpness of the image is emphasized by high-frequency-filtering the image signal when the focusing state is the in-focus state.

6. The method of claim 4, wherein the blurring of the image is emphasized by low-frequency-filtering the image signal when the focusing state is the blurred state.

7. The method of claim 1, wherein the calculating a focus value step comprises:
setting a cutoff frequency;
obtaining a filtered image signal by performing high-frequency-filtering on the image signal, wherein the high-frequency-filtering is based upon the cutoff frequency; and
integrating the filtered image signal.

8. The method of claim 7, wherein the cutoff frequency is selected from the group consisting of:
a frequency larger than a hundredth of a sampling frequency for processing the image signal; and
a frequency smaller than a tenth of the sampling frequency.

9. The method of claim 2, wherein in a graphical representation of focus values with respect to the position of the focal lens,
a first region encompassing the area between two change points of the focus value is defined as the in-focus state; and
a second region located outside the first region is defined as the blurred state.

10. The method of claim 2, wherein the focusing state is determined by comparing the focus value at a current focal lens position with the focus value at a previous focal lens position.

11. The method of claim 10, the method further comprising:
calculating an inclination between the current focal lens position and the previous focal lens position;
comparing the inclination with a first reference value and a second reference value which is greater than the first reference value;
determining that a current focusing state is the blurred state if the inclination is smaller than the first reference value; and
determining that the current focusing state is the in-focus state if the inclination is greater than the second reference value.

12. The method of claim 11, further comprising
operating a focus motor to move the focal lens, wherein the focus motor moves a first number of steps from a first starting point to a first ending point;
calculating the focus value at each of the first number of steps taken by the focus motor;
determining a first maximum focus value among the focus values calculated for the first number of steps;
moving the focal lens to a position corresponding to the first maximum focus value;
operating the focus motor to take a second number of steps, wherein the second number of steps is smaller than the first number of steps;
calculating the focus values for the second number of steps at a second motor starting point and a second motor ending point;
determining a second maximum focus value from among the first maximum focus value and the focus values at the second motor starting point and the second motor ending point;
moving the focal lens to a position corresponding to the second maximum focus value;
operating the focus motor to take a third number of steps, wherein the third number of steps is smaller than the second number of steps;
calculating the focus values for the third number of steps at a third motor starting point and a third motor ending point;
determining a third maximum focus value from among the second maximum focus value and the focus values at the third motor starting point and the third motor ending point; and
moving the focal lens to a position corresponding to the third maximum focus value.

13. The method of claim 12, wherein the first number of steps is 8.

14. The method of claim 12, wherein the second number of steps is 4.

15. The method of claim 12, wherein the third number of steps is 2.

16. A digital photographing apparatus, the apparatus comprising:
an optical system that receives light from a subject to be photographed by the apparatus, wherein the optical system includes a focal lens;
a digital processor that receives signals representing the light received by the optical system and generates an image based on the signals;
a display screen for displaying the image; and
means for changing the sharpness of the displayed image based on a focus value.

17. The apparatus of claim 16, further comprising a correlation double sampler and analog-to-digital converter that processes analog signals output from a photoelectric converter, removes high frequency noise from the signals, alters the bandwidth of the signals, and converts the signals into digital signals, which are processed by the digital processor.

18. The apparatus of claim 16, further comprising a focus motor for moving the focal lens.

19. The apparatus of claim 16, wherein the digital processor determines a current focusing state based upon a current focus value.

20. A computer-readable medium having embodied thereon a computer program for performing steps comprising:
receiving light through a focal lens;
generating an image signal based on the received light;
calculating a focus value based on the high frequency component of the image signal;
displaying, based on the image signal, an image on a display screen; and
changing a sharpness of the displayed image based on the focus value.
